(19) United States
(12) Patent Application Publication
(10) Pub. No.: US 2020/0329681 A1
(43) Pub. Date: Oct. 22, 2020

(54) AQUARIUM OR TERRARIUM

(71) Applicants: Gerd Lukoschus, Userin (DE); Frank Wolf, Torgelow (DE)

(72) Inventors: Gerd Lukoschus, Userin (DE); Frank Wolf, Torgelow (DE)

(21) Appl. No.: 16/959,213

(22) PCT Filed: Mar. 19, 2018
(86) PCT No.: PCT/DE2018/000076

§ 371 Date: Jun. 30, 2020

(30) Foreign Application Priority Data
Jan. 5, 2018 (DE) 10 2018 000 271.4
Jan. 5, 2018 (DE) 20 2018 000 220.8

(51) Int. Cl. A01K 63/00; A01K 63/04; A01K 63/06

(52) U.S. Cl. CPC A01K 63/006; A01K 63/042; A01K 63/065; A01K 63/06; A01K 63/047

(57) ABSTRACT

An aquarium or terrarium (7) with a gravel and/or sand layer (6) arranged in the aquarium or terrarium (7), at least having a base element (4) which is arranged at a distance from the base of the aquarium or terrarium (7). The at least one base element (4) is used as a support for the sand and/or gravel layer (6) in that the sand and/or gravel is rigidly connected to the respective base element (4).

The invention relates to an aquarium or terrarium and is intended in particular to facilitate the cleaning thereof.

The bottom ground of aquariums and terrariums is, as a rule, composed of a plant substrate, a gravel and sand layer, and/or a mixture of the stated components. The problem is that the plant substrate must be exchanged after a certain time and then the gravel and sand layer located thereon must be removed. The separation of these layers from one another is associated with substantial effort. A further disadvantage is that contaminations occurring regularly during operation, consisting of dead plant remains and residue of feed not consumed as well as excrement produced by the animals, must be disposed of. In so doing, the actual top layer of gravel and sand or the mixture thereof is damaged during the suctioning and the smaller parts of the layer are suctioned off. An additional disadvantage is that loose parts of the gravel and/or sand layer block up the suction opening.

The state of the art offers several suggestions for cleaning contaminated aquariums. For example, DE 24 16 365 A1 suggests a bottom element in the form of a bottom plate being spaced apart from the bottom of the aquarium. Contaminations are intended to be collected in this space and suctioned therefrom. The solution according to DE 72 17 042 U functions in a similar fashion. DE 40 11 212 A1 improves upon these solutions in that the bottom element is intended to be able to be composed of individual parts in order to ensure adjustment to the size of the aquarium.

Even if these solutions improve the filtering of the water, the aforementioned problems with the gravel and sand layers still remain. The extent to which planting with natural plants can be realized is also unclear.

It is the object of the invention to facilitate the cleaning of the aquarium while maintaining the possibilities of planting in the aquarium/terrarium and/or the use of sand and gravel.

The object is achieved with the features of Claim 1. Advantageous embodiments are the subject of the sub-claims.

In an aquarium or terrarium with a gravel and/or sand layer arranged in the aquarium or terrarium and having at least one bottom element which is arranged spaced apart from the bottom of the aquarium, it is proposed according to the invention that the at least one bottom element serve as a carrier for the sand and/or gravel layer by being fixedly connected to the respective bottom element.

This way, cleaning is possible without sand and/or gravel being lost. In the simplest case, the at least one bottom element is removed and rinsed. However, the at least one bottom element can also be suctioned.

A supplementary further advantageous cleaning possibility is created when the at least one bottom element has spacing or supporting nubs on the bottom side or, beneath the bottom element, a flat nub carrying mat with nubs pointing in the direction of the bottom element is arranged on which the bottom element rests or the bottom element has a double-walled structure with selectively placed spacers between the double walls, each for forming a collecting space for suctionable foulants, deposited matter and fecal matter which enter into the collecting space through openings in the at least one bottom element. In this case, the embodiment with a double-walled structure corresponds to a sandwich structure.

The at least one bottom element or the nub carrying mat are then intended to be equipped with terminals for at least one airing element and/or one suction pipe which are open in the direction of the interior of the aquarium/terrarium or the collecting space and are preferably designed for a plug-in connection with a secondary hose on the bottom side. A filter segment, preferably being mechanically driven, can further be arranged in the bottom element in the sandwich structure. A further advantageous embodiment provides that the one or the multiple bottom elements or, if present, the nub carrying mat are arranged to rest on a layer made of plant substrate arranged in the aquarium or terrarium on the bottom side and that these are equipped with apertures through which natural plants are insertable into the plant substrate. This way, the planted aquarium or terrarium can be maintained in its natural beauty.

Furthermore, bottom waves of the plant substrate are conceivable, although this requires the bottom elements to be made of a flexible material. In this case, it has proven effective if the flexible material of the bottom element includes a preferably lattice- or net-like structure in order to stabilize in particular applied deformations in the surface and to save the flexible material used.

Preferably, foam- and/or silicone-like materials or equivalent materials corresponding to the state of the art are used as the flexible material for a bottom element.

Depending on its use, the bottom element can also be manufactured in a rigid design independent of the type of material.

The sand and/or gravel is made of natural and/or artificial materials.

It is understood that both the materials for the bottom element and those for the sand/gravel contain no harmful substances which could harm the plants and animals in the aquarium or terrarium. Moreover, these materials must be water-neutral.

The bottom elements and/or the nub carrying mat are preferably produced and sold in the standard sizes of aquariums or terrariums. Naturally, it should also be possible to buy a corresponding bottom material from the reel and then cut it to form the bottom element or bottom elements or nub carrying mat.

It is advantageous if the at least one bottom element and/or the nub carrying mat is/are equipped with engagement opening or tongues or eyelets, preferably in the edge area, for being engaged with during removal from the aquarium or terrarium.

Moreover, a further embodiment provides that the bottom element is able to be composed of portions. These portions may simply overlap each other or can be directly connected to each other by corresponding connection means, e.g. Velcro closures. This is also the case for the nub carrying mat, if used.

A further embodiment provides that the at least one bottom element or the nub carrying mat are equipped with terminals for at least one airing element and/or one suction pipe which are open in the direction of the interior of the aquarium/terrarium and are preferably designed for a plug-in connection with a secondary hose on the bottom side. This way, when decorating the aquarium or terrarium, supply and discharge pipes can be laid during the assembly and are non-visibly arranged under the one or the multiple bottom elements.

By implementing one or multiple bottom elements, lighting objects can also be advantageously achieved. For example, a further embodiment provided that the one or the multiple bottom elements are equipped with light elements which shine into the aquarium/terrarium and/or cast light into the one or the multiple bottom elements, wherein the emitted light is uni- or multicolored.

Moreover, a flat heater can be installed in the nub carrying mat as well as the bottom element.

The invention shall be explained with reference to the drawing. Therein:

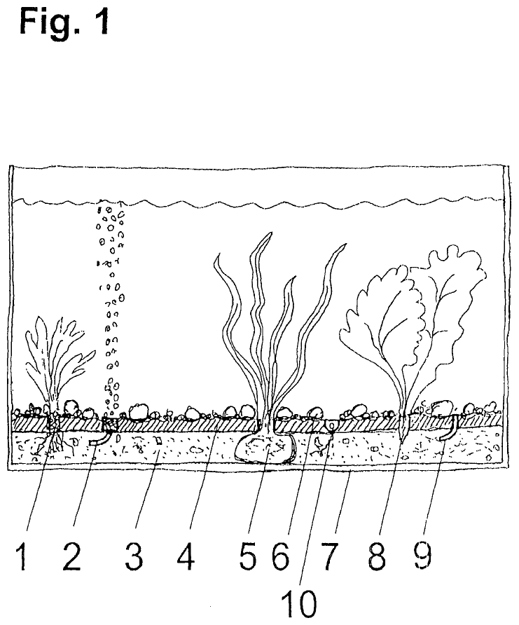

FIG. 1 shows an aquarium with a mobile bottom element with integrated materials and

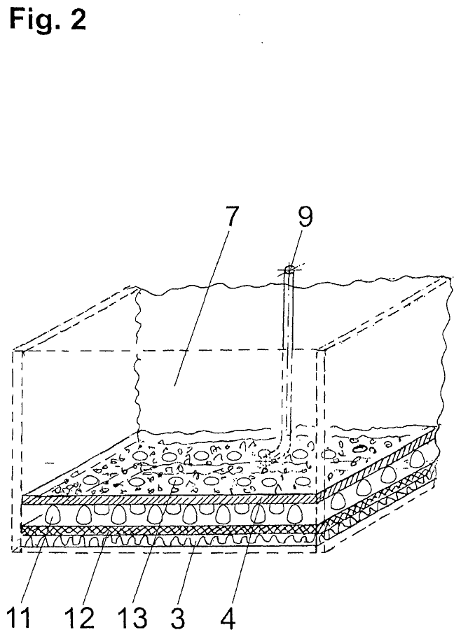

FIG. 2 shows an aquarium with an additional nub carrying mat.

In FIG. 1, the section of an aquarium 7 with the typical equipment is shown. The lower bottom layer 3 consists of a plant substrate. Thereon, the mobile element 4 with the integrated gravel 6 and/or sand 6 is laid. The aquarium plant 1 receives one of the provided or cut-outable openings for growing into the bottom layer 3 made of plant substrate. If no substrate is used, plant imitations 8 and/or similar artificial designs are plugged or locked into one of the provided or cut-outable openings. In or on the bottom element 4, one or multiple airing elements with terminal pipes 2 and/or suction pipes 9 are arranged. If no continuous substrate layer made of a plant substrate is used, it is possible to supply the natural plant with substrate in locally provided containers 5. One or more light sources 10 may also be integrated in the bottom element 4.

FIG. 2 shows an aquarium 7 in which a nub carrying mat 12 is arranged between the lower layer 3 made of plant substrate and the bottom element 4. The nubs 11 of the nub carrying mat 12 point in the direction of the bottom element 4.

The nub carrying mat 12 rests on the layer 3 and the bottom element 4 is supported on the nubs 11. Due to this arrangement, a collecting space for foulants, deposited matter and fecal matter is created between the nub carrying mat 12 and the bottom element 4. This matter can be suctioned out of the collecting space via a terminal 9 for a suction pipe. The foulants, deposited matter and fecal matter enter into the collecting space through unoccupied apertures for aquarium plants or unoccupied insert openings for decorations and/or additional openings 13 of the bottom element 4.

If plant substrate is used, the additional openings 13 can also be utilized for gas exchange or for circulation exchange.

A flat heater can be installed in the nub carrying mat 12 as well as the bottom element 4.

### LIST OF REFERENCE NUMERALS

1 natural plant

2 terminal for air supply

3 layer of plant substrate

4 bottom element

5 natural plant with substrate container

6 gravel and/or sand layer in and on the bottom element

7 Aquarium or terrarium

8 artificial plant

9 terminal for suction pipe

10 light elements

11 nubs

12 nub carrying mat

1.) An aquarium or terrarium (7) with a gravel or sand layer (6) arranged in the aquarium or terrarium (7) and having at least one bottom element (4) that is arranged spaced apart from a bottom of the aquarium or terrarium (7), wherein the at least one bottom element (4) serves as a carrier for a sand and/or gravel layer (6) by the sand and/or gravel layer being fixedly connected to the at least one bottom element (4).

2. The aquarium or terrarium (7) according to claim 1, wherein
the at least one bottom element (4) has a bottom side and has spacing or supporting nubs on the bottom side
or,
beneath the bottom element (4), a flat nub carrying mat (12) with nubs (11) pointing in the direction of the bottom element (4) is arranged on which the bottom element (4) rests, or
the bottom element (4) has a double-walled structure with selectively placed spacers between the double walls,
each for forming a collecting space for suctionable foulants, deposited matter and fecal matter which enter into the collecting space through openings in the bottom element (4).

3. The aquarium or terrarium (7) according to claim 2, wherein the at least one bottom element (4) or, if present, the nub carrying mat (12) rests on a layer (3) made of plant substrate arranged in the aquarium or terrarium on the bottom side and the at least one bottom element (4) and, if present, the nub carrying mat (12) are equipped with apertures through which natural plants (1) are insertable into the plant substrate.

4. The aquarium or terrarium (7) according to claim 1, wherein the at least the one or the multiple bottom elements (4) are equipped with insert openings for artificial plants (8) or for other decorations.

5. The aquarium or terrarium (7) according to claim 2, wherein openings in the collecting space are additional openings (13) and/or free apertures for plant substrate and/or free insert openings for decorations.

6. The aquarium or terrarium (7) according to claim 1, wherein the at least one bottom element (4) is made of a flexible material.

7. The aquarium or terrarium (7) according to claim 6, wherein the flexible material of the bottom element (4) includes a preferably lattice- or net-like structure in order to stabilize in particular applied deformations in the surface and to reduce the flexible material used.

8. The aquarium or terrarium (7) according to claim 1, wherein the at least one bottom element (4) is made of a foam- and/or silicone-like material.

9. The aquarium or terrarium (7) according to claim 2, wherein the at least one bottom element (4) and/or the nub carrying mat (12) is/are equipped with engagement opening or tongues or eyelets for being engaged with during removal from the aquarium or terrarium.

10. The aquarium or terrarium (7) according to claim 1, wherein the sand or gravel is made of natural and/or artificial materials.

11. The aquarium or terrarium (7) according to claim 2, wherein the at least one bottom element (4) and/or the nub carrying mat (12) corresponds to or are cuttable to the standard size of aquariums or terrariums.

12. The aquarium or terrarium (7) according to claim 2, wherein the at least one bottom element (4) or the nub carrying mat (12) is equipped with terminals (2, 9) for at least one airing element and/or one suction pipe which are open in the direction of the interior of the aquarium/terrarium or the collecting space.

13. The aquarium or terrarium (7) according to claim 2, wherein a filter segment is arranged between the walls in a double-walled bottom element (4).

14. The aquarium or terrarium (7) according to claim 2, wherein the at least one bottom element (4) or the nub carrying mat (12) is equipped with light elements (10) which shine into the aquarium/terrarium (7) and/or cast light into the one or the multiple bottom elements (4), wherein the emitted light is uni- or multicolored.

15. The aquarium or terrarium (7) according to claim 2, wherein the at least one bottom element (4) or, if present, the nub carrying mat (12) rests on a layer (3) made of a material other than plant substrate arranged in the aquarium or terrarium on the bottom side and the at least one bottom element (4) for configuring bottom unevennesses and, if present, the nub carrying mat (12) are equipped with apertures through which natural plants (1) are insertable into the plant substrate.

16. The aquarium or terrarium (7) according to claim 3, wherein the layer made of plant substrate (3) is formed from individual substrate containers (5).

17. The aquarium or terrarium (7) according to claim 2, wherein a flat heater is integrated in the nub carrying mat (12) or the bottom element (4).

18. The aquarium or terrarium (7) according to claim 2, wherein the at least one bottom element (4) and/or the nub carrying mat (12) is/are equipped with engagement opening or tongues or eyelets in an edge area for being engaged with during removal from the aquarium or terrarium.

19. The aquarium or terrarium (7) according to claim 2, wherein the at least one bottom element (4) or the nub carrying mat (12) is equipped with terminals (2, 9) for at least one airing element and/or one suction pipe which are open in the direction of the interior of the aquarium/terrarium or the collecting space and are designed for a plug-in connection with a secondary hose on the bottom side.

20. The aquarium or terrarium (7) according to claim 2, wherein a filter segment is arranged removably between the walls in a double-walled bottom element (4).
